(19) United States
(12) Patent Application Publication
(10) Pub. No.: US 2014/0210311 A1
(43) Pub. Date: Jul. 31, 2014

(54) Noiseless Electromechanical Motor

(71) Applicants: Niklas Snis, Uppsala (SE); Stefan Johansson, Uppsala (SE)

(72) Inventors: Niklas Snis, Uppsala (SE); Stefan Johansson, Uppsala (SE)

(73) Assignee: PIEZOMOTOR UPPSALA AB, Uppsala (SE)

(21) Appl. No.: 14/238,859

(22) PCT Filed: Aug. 16, 2011
(86) PCT No.: PCT/EP2011/064095

§ 371 Date: Mar. 18, 2014

(51) Int. Cl. H02N 2/04

(52) U.S. Cl. CPC H02N 2/04
USPC 310/323.02

(57) ABSTRACT

An electromechanical motor (1) comprises an object (2) to be moved, a vibrator beam (10), at least two protruding portions (12) attached to the vibrator beam, a normal force providing arrangement (40) applying a normal force (F) between the object and actuating ends (11) of the protruding portions for interaction with the object. The vibrator beam has vibrator beam electrodes (18A, 18B) for exciting at least one vibrator beam active volume (14) of electromechanically active material, enabling bending the vibrator beam perpendicular to a main extension direction of the vibrator beam and along the protruding portions (12). Control electronics (50), connected to the vibrator beam electrodes, is configured for providing resonance electrical signals causing the vibrator beam active volume to induce a resonant bending vibration and is further configured for providing quasi-static electrical signals causing a quasi-static motion of the actuating ends, superimposed on motion caused by the resonant bending vibration.

### TECHNICAL FIELD

The present invention relates in general to fine positioning motors, and in particular to motors driven by excitation of electromechanically active elements.

### BACKGROUND

Motors driven by the action of shape changes of electromechanical elements have been used for a while, in particular for small motors and/or where fine positioning is of importance. Non-exclusive examples of electromechanically active materials are piezoelectric materials and electrostrictive materials. Electromechanical motors can be divided in two main groups; ultrasonic and positioning motors.

The ultrasonic motors (UM), which operate in the ultrasonic frequency range, are typically relatively fast while the positioning motors (PM) that operate at some few kHz are slow in comparison. The great advantages with the PMs are the possibility to reach resolutions better than nanometres while an UM typically has a resolution in the order of pm. Less known and therefore less utilized is the higher ratio of force-to-volume of the PM in comparison with an UM. This property is partially explained by the possibility to optimise the PM from a force point of view. An important advantage of a UM is the operation in the inaudible frequency range. The motors are completely silent to the human ear as long as the motor is running with constant operating speed. The positioning motors are on the other hand typically operating in the audible frequency range and the noise can be a major problem in applications where motors are in operation close to humans. A few experimental PM designs in which the actuators are intended to be driven with ultrasonic frequencies have been tested. However, such designs often account heating problems.

Problems with prior art electromechanical motors are thus that fine positioning motors typically cause disturbing noise and that silent electromechanical motors have an in many applications insufficient positioning accuracy.

### SUMMARY

A general object of the present invention is to provide an electromechanical motor concept, which allows designing silent fine positioning motors. This object is achieved by devices and methods according to the enclosed independent patent claims. Preferred embodiments are defined by the dependent claims. In general words, in a first aspect, a electromechanical motor comprises an object to be moved, a vibrator beam, at least two protruding portions, a normal force providing arrangement, control electronics, and electrical connections. The vibrator beam has a generally elongated shape. The vibrator beam has a largest dimension in a main extension direction. The vibrator beam has at least one vibrator beam active volume of electromechanically active material and vibrator beam electrodes for exciting the vibrator beam active volume(s). The vibrator beam active volume(s) and the vibrator beam electrodes are arranged for enabling bending the vibrator beam in a beam flexural direction perpendicular to the main extension direction when the vibrator beam active volume(s) is(are) excited. The protruding portions are attached to the vibrator beam by a respective attachment end. The protruding portions protrude from the vibrator beam in the beam flexural direction. The protruding portions have actuating ends, arranged as the only interaction connections between the vibrator beam and the object to be moved. The actuating ends are situated opposite to the attachment ends. The normal force providing arrangement is configured for applying a normal force between the object to be moved and the actuating ends. The control electronics is configured for providing electrical signals for excitement of electromechanically active material. The electrical connections connect the control electronics and the vibrator beam electrodes. The control electronics is configured for providing resonance electrical signals causing the vibrator beam active volume(s) to induce a resonant bending vibration in the vibrator beam. The control electronics is further configured for providing quasi-static electrical signals causing a quasi-static motion of the actuating ends of the protruding portions, superimposed on motion caused by the resonant bending vibration.

In a second aspect, a method for driving an electromechanical motor comprises applying of a normal force between an object to be moved and actuating ends of at least two protruding portions attached to a vibrator beam. The vibrator beam has a generally elongated shape. The vibrator beam has a largest dimension in a main extension direction. The protruding portions are attached to the vibrator beam by a respective attachment end. The actuating ends, intended as the only interaction connections between the vibrator beam and the object to be moved, are situated opposite to the attachment ends. Resonance electrical signals are provided to vibrator beam electrodes of a vibrator beam for exciting at least one vibrator beam active volume of electromechanically active material causing the vibrator beam active volume(s) to induce a resonant bending vibration in the vibrator beam in a beam flexural direction perpendicular to the main extension direction. The protruding portions protrude from the vibrator beam in the beam flexural direction. Quasi-static electrical signals are provided causing a quasi-static motion of the actuating ends of the protruding portions, superimposed on the resonant bending vibration.

One advantage with the present invention is that presented positioning motor solves the problem with generation of audible noise at the same time as the positioning resolution and force/volume ratio is maintained. The solution is based on a vibrator beam that has at least two protruding portions in contact with a body to be moved. The vibrator beam operates in resonance at an ultrasonic range and by the superimposed quasi-static motion, the actuating ends on the protruding portions move along semi-elliptical trajectories during the driving operation. The protruding portions can in preferred embodiments be operated quasi-statically, i.e. at a frequency lower than a resonance frequency, to make fine positioning. The combination of resonant and quasi-static movements thus makes it possible to design a motor for higher force/volume ratio than traditional UM's.

### BRIEF DESCRIPTION OF THE DRAWINGS

The invention, together with further objects and advantages thereof, may best be understood by making reference to the following description taken together with the accompanying drawings, in which:

FIGS. 1A-C are schematic drawings of flexural vibration resonance modes of a beam;

FIGS. 2A-C are schematic drawings of flexural vibration resonance modes of a beam hinged at its ends;

FIGS. 3A-C are schematic drawings of flexural vibration resonance modes of a beam hinged at points in its interior;

FIGS. 4A-E are schematic drawings of flexural vibration resonance modes of a beam provided with protruding portions in the flexural direction;

FIG. 5A is a schematic drawing of an embodiment of an electromechanical motor;

FIG. 5B is a schematic illustration of an embodiment of electrical connections to the electromechanical motor according to FIG. 5A;

FIG. 6 is a schematic illustration of an embodiment of a vibrator beam with protruding portions;

FIG. 7 is a flow diagram of steps of an embodiment of a method for driving an electromechanical motor;

FIG. 8A is a schematic illustration of another embodiment of a vibrator beam with protruding portions;

FIG. 8B is a schematic illustration of an embodiment of electrical connections to the vibrator beam according to FIG. 8A;

FIG. 9A illustrates nodal positions of a vibrator beam;

FIGS. 9B-D illustrate embodiments of support for a vibrator beam;

FIG. 10 schematically illustrates an embodiment of a vibrator beam with protruding portions at anti-nodes of a flexural vibration;

FIG. 11 is a schematic illustration of another embodiment of a vibrator beam with passive protruding portions;

FIGS. 12A-B are schematic illustrations of embodiment of electrical connections to vibrator beams with more than two independently excitable part volumes of the active volumes; and

FIGS. 13A-C are schematic illustrations of embodiments of electromechanical motors with more than one vibrator beam.

### DETAILED DESCRIPTION

Throughout the drawings, the same reference numbers are used for similar or corresponding elements.

A UM can be driven at high frequencies in an inaudible frequency range due to the fact that high frequency resonances in the actuators and/or object to be moved can be utilized. Supplied electrical energy is stored as mechanical vibration energy at resonance. For this reason, the energy efficiency of the exciting signals is increased and the energy losses in the material, resulting in heating of the actuators, can be reduced. In order to use such a resonance for driving purposes, it is advantageous to find a resonance that will move actuating parts of the actuators e.g. in elliptical paths. This put certain limitations on the possible excitation modes and actuator designs. Another important feature of a UM is that there are difficulties in stopping the operation very accurately. Even when the power supply to the active elements is interrupted, the resonance vibration still contains energy, which may continue to move a body also some time after the power interruption. This behaviour makes it difficult to operate an UM all the way up to a predetermined position.

An elliptical path or other moving actuator trajectories used for UM operation and some stepping PM operation can be seen as a two superimposed motions; one “lifting” motion perpendicular to the driving surface of the object to be moved and one “translation” motion parallel to the driving surface of the object to be moved. By phase-shifting sinusoidal lifting and translation motions, e.g. by 90 degrees, the superimposed motion will become an elliptical motion. By using other phase shifts, other types of linear or tilted elliptical motion can be achieved. A motion useful for moving an object in UM operation can, however, only be achieved if both part motions are present in some form. The present invention utilizes this insight for presenting a motor solution where a resonant motion is combined with a quasi-static motion to achieve a superimposed motion suitable for moving an object. By this approach, a substantial part of the total power used for moving the object can be provided by the resonance motion thereby causing small heat dissipation, whereas a quasi-static motion contributes with advantageous positioning properties.

In the present invention, a basic design, having a vibrating bending beam on to which protruding portions are attached, is explored.

By quasi-static motion is understood movements where the forces due to inertia can to a reasonable extent be neglected. Typically the movement can be considered quasi-static up to 40% of the resonance frequency.

Before the actual embodiments of the present invention are presented in detail, some properties of bending vibrations of beams may be discussed for increasing the understanding of the vibration properties.

A beam is in the present disclosure intended to characterize a generally elongated shape, i.e. a structure that has a relatively high aspect ratio. An extension direction of a beam can be defined as the direction of a largest dimension of the beam. A beam has certain mechanical resonance properties. A beam can e.g. be bent perpendicular to the extension direction. Different parts of the beam thereby perform essentially translation movements or strokes perpendicular to the extension direction. In the present disclosure, this is referenced to as a bending motion or equivalently a flexural motion. This should be kept distinguished from longitudinal vibrations, where parts of the beam are moved by pressure waves within the beam.

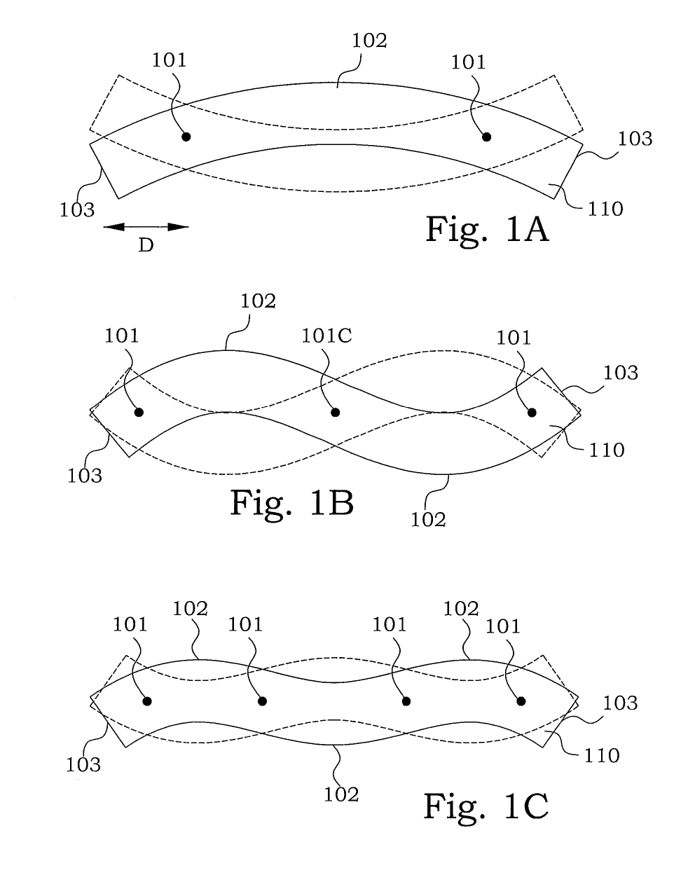

A flexural vibration of a beam has resonance properties depending on the size, shape, mass distribution and type and position of the supports. There is generally a first harmonic frequency, first resonance frequency or ground tone. Moreover, there are also generally higher harmonics or overtones occurring at higher frequencies. A totally free floating homogeneous beam 110 has a first harmonic resonance giving a stroke with an antinode 102 between two nodes 101 situated a distance D from the respective beam ends 103, as illustrated in FIG. 1A. A second harmonics resonance presents a node in the centre, two antinodes 102 outside the central node 101C and two further nodes 101 outside the antinodes 102, as illustrated in FIG. 1B. A third harmonics resonance is schematically illustrated in FIG. 1C. Selecting dimensions of the beam to fit within micromotors, the corresponding resonance frequencies will be situated close to or within the ultrasonic range. Note that the strokes of the beam are highly exaggerated in the figures in comparison with what would be the case in actual actuator devices, to facilitate the reader understanding of the basic vibration principles.

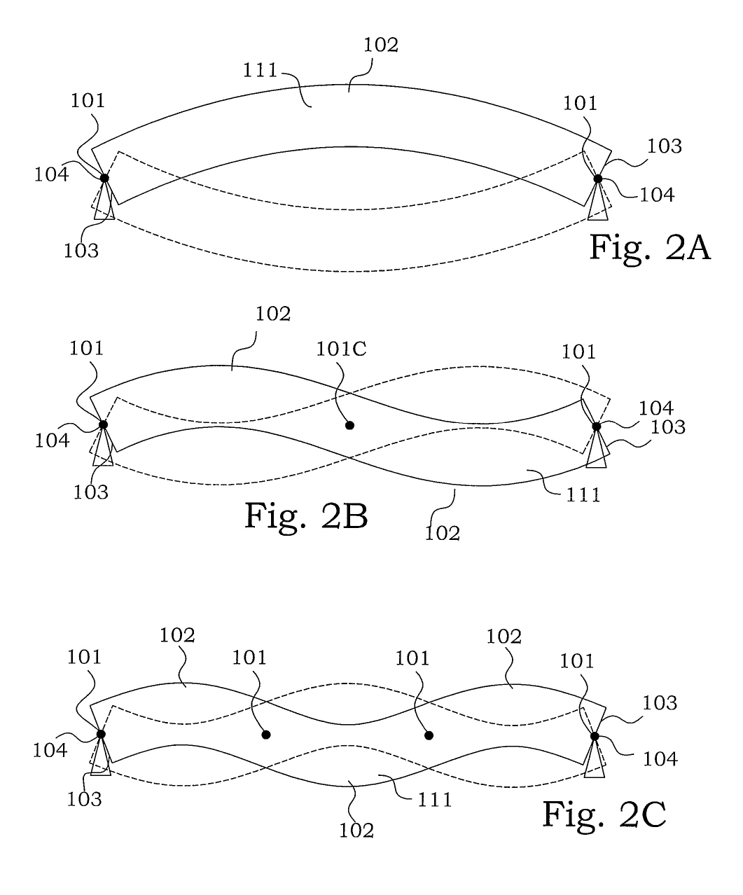

When the boundary conditions are changed, so does the resonance behaviour. A beam 111 that is hinged at both its ends 103, i.e. where the ends 103 are allowed to tilt but not to be translated, will present other flexural resonance shapes and frequencies, as shown in FIGS. 2A-C. The outermost nodes 101 will always be positioned at the ends 103, simply due to the boundary conditions set by the hinges 104. The resonance frequencies will consequently also differ. It can be noticed that, in analogy with the free floating beam, the first harmonic vibration mode has one anti-node and two nodes (if the free ends of the free floating beam are not considered as “anti-nodes”), the second harmonic vibration mode has two anti-nodes and tree nodes and the third harmonic vibration mode has three anti-nodes and four nodes.

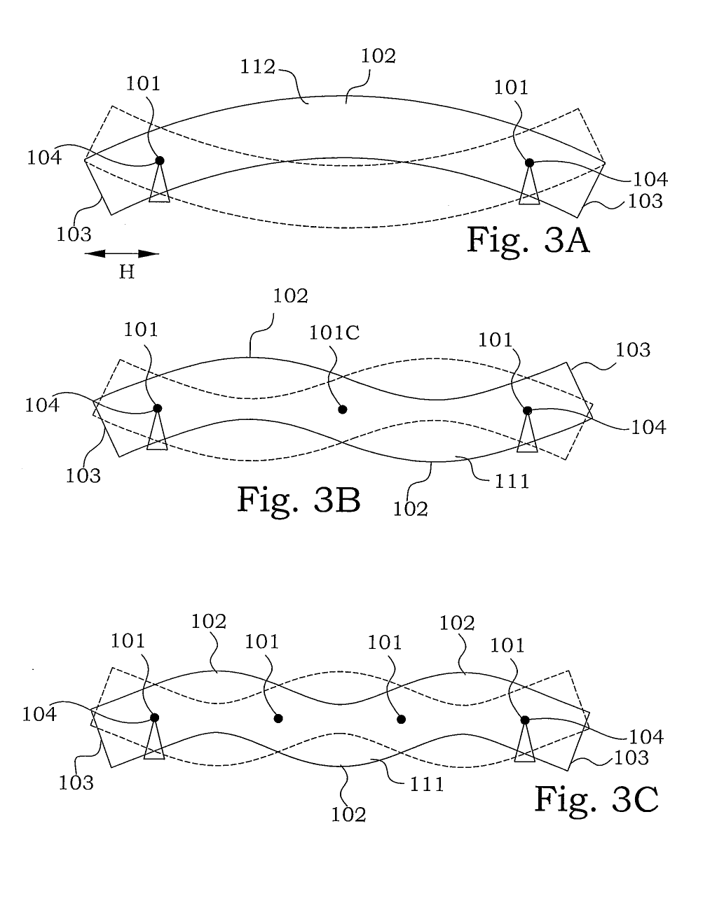

FIGS. 3A-C illustrates another example of flexural resonance modes of a vibrating beam. In this example, the beam 112 is hinged at positions a (non-zero) distance H from the end. Such a restriction will lead to that nodes 101 always have to appear at these distances and the beam 112 will vibrate with a free end 103. If the hinged positions are selected to coincide with node positions of a totally free floating beam, such a resonance mode will have similar properties. Such resonance modes will generally also be the most energy effective ones and easy to excite.

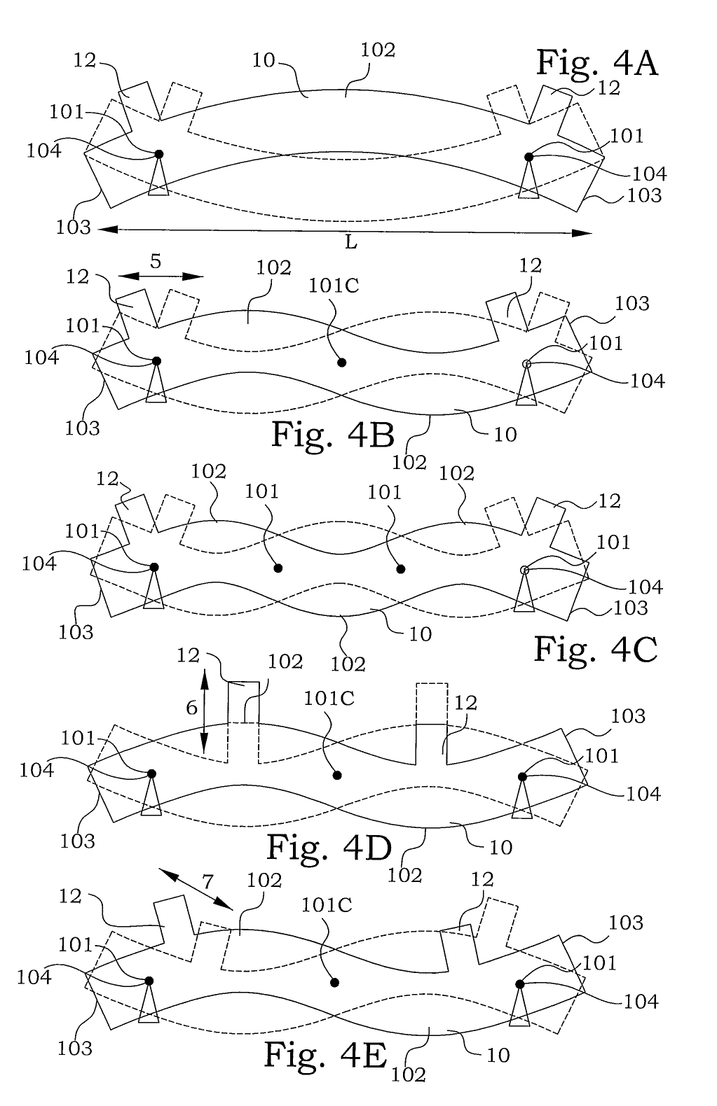

FIGS. 4A-C illustrates a modification of the beam of Figs. A-C, where two protruding portions 12 are attached to a vibrator beam 10. Such attachments will generally affect the flexural vibration properties. The distribution of mass is changed, the moment of inertia will differ, and so on, which will influence the vibration properties. However, if the protruding portions 12 are small compared to the beam extension L, the effect will in general be relatively moderate modifications of the resonance frequencies, and the general vibration mode shapes are influenced very little. In particular, if the protruding portions 12 are provided at nodes 101 of a resonance vibration, the influence will be very small. In a general case, the protruding portions 12 are participating in the beam vibration as a passive part, thus contributing essentially only by its mass and inertia. However, as illustrated further below, one may also provide measures to change this. If the protruding portions 12 are small compared to the beam extension L, resonances connected to vibrations within the protruding portions 12 themselves typically occur at a much higher frequency than for the entire vibrator beam 10 and may at least for the first few harmonics of the main beam resonance vibration be more or less neglected.

In the above case, the protruding portions 12 are provided at the location of a node in the flexural resonance. It can be noticed that the outer end of the protruding portions 12 then basically performs a linear reciprocating motion in the direction of the main extension of the vibrator beam 10. This is illustrated by the arrow 5 in FIG. 4B. The flexural vibration of the vibrator beam 10 is thus translated into a linear motion along the extension of the vibrator beam 10. By positioning the protruding portions 12 elsewhere, will change the situation. In FIG. 4D, a situation is illustrated, where the protruding portions 12 are provided at the anti-nodes of the flexural resonance vibration instead. The result is that the tip of the protruding portions 12 now instead reciprocates linearly in a direction perpendicular to the vibrator beam 10 main extension, i.e. in the flexural direction, as illustrated by arrow 6. Yet another configuration is illustrated in FIG. 4E. Here, the protruding portions 12 are provided at a position between the anti-nodes and the nodes of the flexural resonance vibration. The resulting motion becomes a linear motion as illustrated by the arrow 7, inclined with respect to both direction 5 and 6 (of FIGS. 4B and 4D).

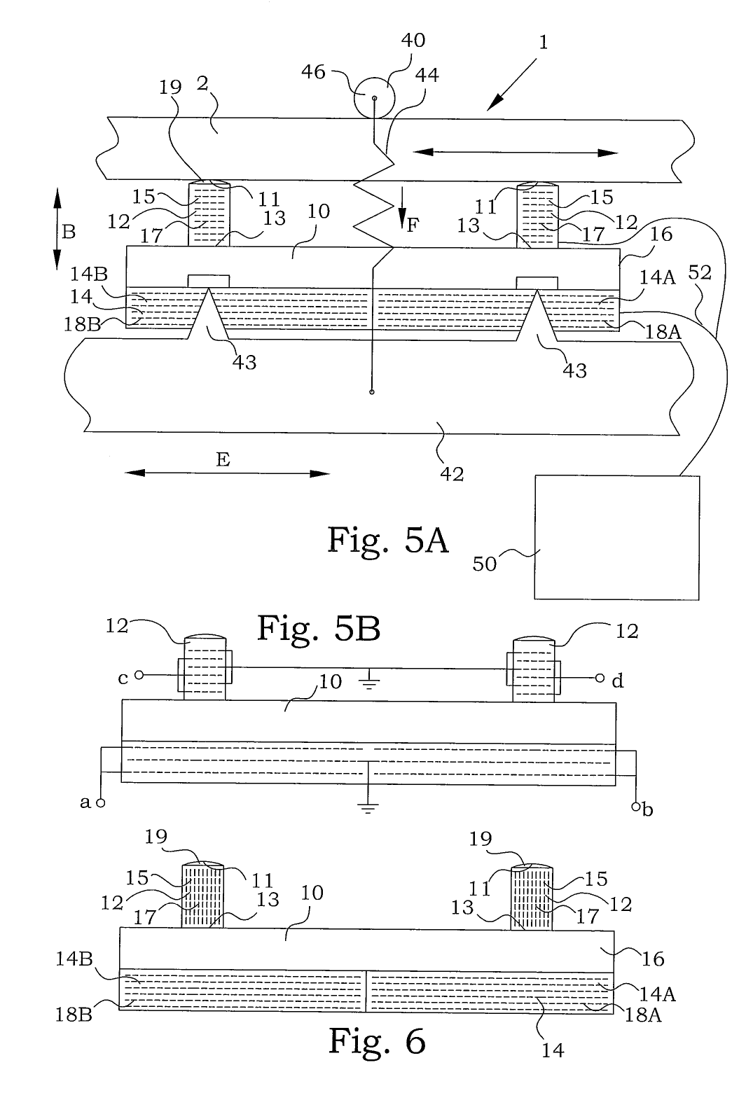

Some embodiments will further explain the usefulness of such configuration. FIG. 5A illustrates schematically an embodiment of an electromechanical motor 1. The electromechanical motor 1 comprises an object to be moved 2, a vibrator beam 10, two protruding portions 12, a normal force providing arrangement 40, control electronics 50 and electrical connections 52. The vibrator beam 10 has a generally elongated shape. The shape is typically a parallelepiped with one side being considerably larger than the other. The vibrator beam 10 thus has a largest dimension, which defines a main extension direction E. The vibrator beam 10 in the present embodiment has one vibrator beam active volume 14 of electromechanically active material. This vibrator beam active volume 14 is in the present embodiment divided in two part volumes 14A, 14B. Vibrator beam electrodes 18A, 18B are provided for exciting the part volumes 14A, 14B of the vibrator beam active volume 14 independently. In the present embodiment, the vibrator beam active volume 14 is integrated along the main extension direction E with a passive beam portion 16. When the electromechanically active material of the two part volumes 14A, 14B is excited, they exhibit a shape change and in particular a change in the dimension parallel to the main extension direction E. Due to the attachment to the passive beam portion 16, such a dimension change will result in a bending of the vibrator beam 10 in the vertical direction of FIG. 5A. In more general words, the vibrator beam active volume 14 and the vibrator beam electrodes 16 are arranged for enabling bending of the vibrator beam 10 in a beam flexural direction B perpendicular to the main extension direction E when the vibrator beam active volume 14 is excited.

By electromechanically active material is understood a material that changes its shape by an applied electric voltage, field and/or current.

The main extension direction E is also the intended motion direction of the object 2 to be moved, as indicated by an arrow at the object 2.

The two protruding portions 12 are attached to the vibrator beam 10 by a respective attachment end 13. The protruding portions 12 protruding from the vibrator beam 10 in the beam flexural direction B. The protruding portions 12 have respective actuating ends 11. The actuating ends 11 are situated opposite to the attachment ends 13 with respect to the protruding portion 12. In other words, the protruding portions are attached by one end, the attachment end 13, to the vibrator beam and are intended to interact with the object 2 to be moved with an opposite end, the actuating ends 11. The actuating ends 11 are arranged as the only interaction connections for transfer of movement forces between the vibrator beam 10 and the object to be moved 2. The actuating ends 11 are in the present embodiments provided with drive pads 19 adapting the contact properties between the actuating ends 11 and the object 2 to be moved.

The normal force providing arrangement 40 is configured for applying a normal force F between the object to be moved 2 and the actuating ends 11 of the vibrator beam 10. In the figure, the normal force providing arrangement 40 is illustrated as a spring 44, connecting a housing 42 supporting the vibrator beam 10 and a roll 46 being movably supported against the object to be moved 2. This illustration is very schematic, and any arrangements providing a normal force F between the object to be moved 2 and the actuating ends 11 of the vibrator beam 10 can be used. The details concerning how the normal force F is created are not of particular importance for the basic operability of the present invention, as long as the normal force F indeed is provided. There are many solutions according to prior art that will operate well together with the present invention.

The control electronics 50 is configured for providing electrical signals for excitement of electromechanically active material. Such signals are in the present embodiment provided to the vibrator beam electrodes 18A, 18B by the electrical connections 52. The electrical connections 52 thus connect the control electronics 50 and the vibrator beam electrodes 18A, 18B. The control electronics 50 has two main tasks. The control electronics 50 is configured for providing resonance electrical signals causing the part volumes 14A, 14B of the vibrator beam active volume 14 to induce a resonant bending vibration in the vibrator beam 10. The control electronics 50 is additionally configured for providing quasi-static electrical signals causing a quasi-static motion of the actuating ends 11 of the protruding portions 12. Such quasi-static motion becomes superimposed on motion caused by the resonant bending vibration.

As mentioned above, in the present embodiment, the vibrator beam active volume 14 and the vibrator beam electrodes 18A, 18B are configured for exciting two part volumes 14A, 14B independently of each other. This makes it possible to excite one of the part volumes 14A, 14B to exhibit an elongation in the main extension direction E while causing a contraction in the main extension direction E of the other one of the part volumes 14A, 14B. The vibrator beam 10 will by such excitations exhibit a stroke toward the object to be moved 2 at one part and a stroke away from the object to be moved 2 in another part. Such motion resembles the second harmonics of a vibrating beam (c.f. FIG. 4B). By providing an alternating excitation of this kind, the vibrator beam active volume 14 and the vibrator beam electrodes 18A, 18B are thus configured for allowing excitation of a bending motion of the vibrator beam 10 of a second harmonics. By furthermore providing such an excitation with a frequency close to a second harmonics resonance frequency of the vibrator beam 10, a resonance can be excited.

In alternative embodiments, other resonances can be utilized as well. If the first harmonics resonance is to be used, there has to be at least one vibrator beam active volume. The same effect can of course be caused by exciting a plurality of vibrator beam active volumes in phase. In order to efficiently excite the third harmonics resonance, three vibrator beam active volumes are to prefer.

In the embodiment of FIG. 5A, the protruding portions 12 are attached to the vibrator beam 10 at positions in the main extension direction E corresponding to resonance nodes of the bending motion of the vibrator beam 10. During a second harmonics resonance vibration, the protruding portions 12 will then mainly be performing a tilting motion, moving the actuating ends 11 of the protruding portions 12 mainly in a reciprocating manner in the main extension direction E, as discussed in connection with FIG. 4B. Such a reciprocating motion in the main extension direction E can be utilized for causing the motion of the object 2 to be moved as explained further below.

In the present embodiment, the vibrator beam 10 is supported to the housing 42 and/or the normal force providing arrangement 40 at locations at nodes of the bending motion of the vibrator beam 10. The vibrator beam 10 can then simply be supported e.g. on protruding edges 43 of the housing 42 under application of the normal force F for providing a motion which is more or less identical to a motion of a hinged beam (c.f. FIG. 4A-C).

The vibrator arrangement is thus a vibrator beam with protruding portions or “legs” and flexural resonances are used to create movement in the ultrasonic frequency range. In most embodiments presented here, the second harmonic is used, but all flexural resonances can be used in a similar manner. The differences between the various flexural resonances are essentially the nodal positions, the frequency and possible strokes. The choice of flexural resonance harmonic depends on application and performance demands.

In the present embodiment, the vibrator beam comprises a metal beam as a passive beam portion with a piezoceramic element attached on the bottom side, i.e. the vibrator beam active volume. This piezoceramic element is typically a monolithic multilayer with two part volumes. However, as mentioned above, it should be noticed that other flexural resonance harmonics demand different numbers of active part volumes and in some of the special embodiments particular designs of this piezoceramic element may be needed.

As mentioned above, the second harmonics resonance vibration of the vibrator beam 10 causes in the present embodiment the actuating ends 11 of the protruding portions 12 to move back and forth in the main extension direction E. In order to achieve a controllable motion of the object 2 to be moved, such a motion has to be combined with a motion perpendicular to the main extension direction E, and preferably out of phase therewith. In the present embodiment, such a lifting motion is achieved by making also the protruding portions 12 possible to exhibit shape and/or dimensions changes by means of electromechanically active material. To this end, the protruding portions 12 have a respective protruding portion active volume 15 of electromechanically active material and respective protruding portion electrodes 17 for exciting the protruding portion active volume 15. In alternative embodiments, the protruding portions 12 can have a plurality of respective protruding portion active volumes of electromechanically active material. The quasi-static electrical signals provided by the control electronics 50 are in the present embodiment connected to the protruding portion electrodes 17 by a branch of the electrical connections 52. These quasi-static electrical signals are preferably synchronous with the resonance electrical signals, but phase shifted therefrom. The signals are quasi-static electrical signals, since they control the shape changes of the protruding portion active volume 15 of the protruding portions 12, which protruding portions 12 have a first resonance frequency much higher than the provided resonance frequency for the vibrator beam 10. In the present embodiment, the respective protruding portion active volume 15 and the protruding portion electrodes 17 are arranged for causing at least a dimension change of the protruding portion 12 in the beam flexural direction B when a respective protruding portion active volume 15 is excited. In the present embodiment, the protruding portion active volumes 15 and the protruding portion electrodes 17 are configured for exciting the protruding portion active volumes 15 by a d33 mechanism. In such a mechanism, the utilized dimension change occurs in the same direction as the applied electrical field. In other words, the protruding portion electrodes 17 are provided perpendicular to the beam flexural direction B.

There are several different ways of driving a composite beam of the above presented type to generate the desired flexural resonance. With the arrangements of the vibrator beam electrodes as is schematically shown in FIG. 5B, there are two main solutions. In a first solution, both halves of the piezoceramic element are polarised equally. This means that a and b are connected to the same voltage during polarisation. In this case, phases a and b are driven with a phase shift of 180 degrees during operation, in order to excite the second harmonic.

In a second solution, the two halves of the piezoceramic element are polarised with opposite polarity. This means that a and b are connected to opposite voltages during polarisation. In this second case, both phase a and b can be driven by a same voltage signal to generate the second harmonic. The choice of polarisation depends mainly on the selection of piezoceramic material. With a soft piezoceramic with too low coercive field strength, it is not possible to drive the material with a too large voltage signal opposite to the polarisation.

As already discussed above, on top of the vibrator beam, two legs or protruding portions are assembled. They are in the present embodiment positioned above the nodal positions. This means that they will rotate around the nodal point when the vibrator is activated in the second harmonic flexural resonance and any drive pads at the actuating ends of the legs will move in the horizontal direction. They will move synchronously, i.e. tilt in the same direction, and the vertical movement can be neglected. As mentioned above, in this embodiment, these two legs are typically built as a piezoceramic multilayer with one active volume making it possible to elongate the legs by applying a voltage to the phases c and d. These legs are typically polarized in the same way and are also driven with the same voltage signal. This makes it possible to move the drive pads at the actuating ends in the vertical direction. When the tilting and horizontal movements are combined with the proper phase shift, the drive pads will move along an elliptical trajectory. If an object to be moved is pressed against the drive pads with a normal force F in the vertical direction that results in a friction contact between these components during the upper part of the elliptical trajectory, the object will be moved in the horizontal direction, i.e. in the main extension direction E. The phase shift can be adjusted so that the drive pads rotate either clockwise or counter-clockwise along the elliptical trajectory making it possible to drive the motor in both directions.

FIG. 6 illustrates schematically another embodiment of the protruding portions. In this embodiment, the protruding portion active volumes 15 and the protruding portion electrodes 17 are configured for exciting the protruding portion active volumes 15 by a d31 mechanism. In such a mechanism, the utilized dimension change occur perpendicular to the direction in which the electrical field is applied. In other words, the protruding portion electrodes 17 are provided parallel to the beam flexural direction B.

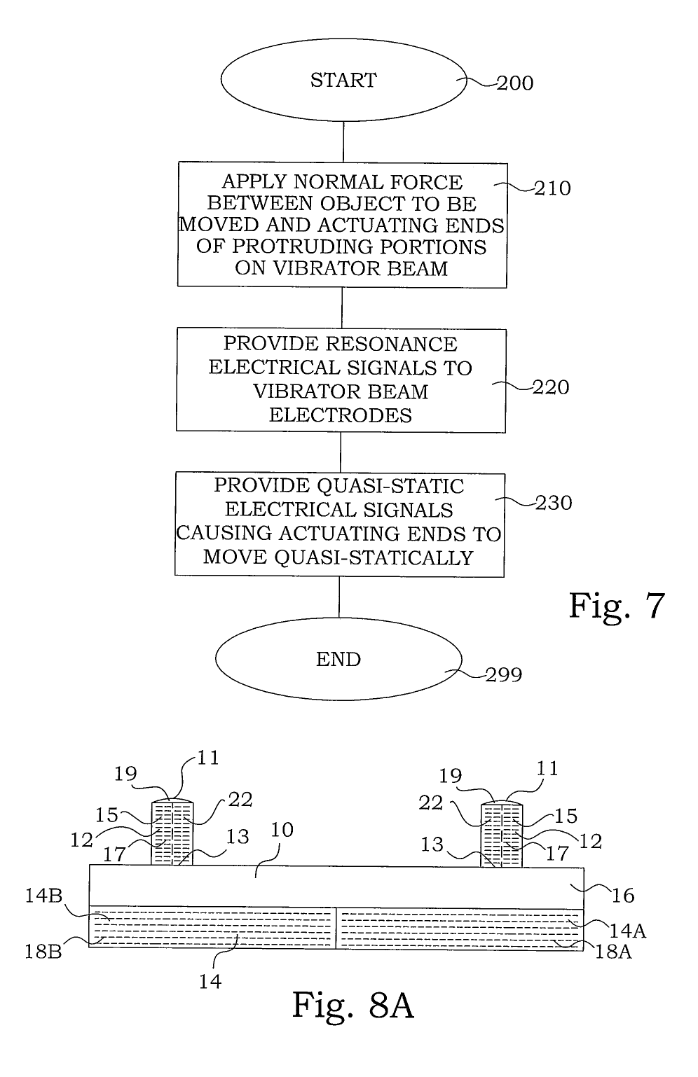

FIG. 7 is a flow diagram of steps of an embodiment of a method for driving a electromechanical motor. The procedure starts in step 200. In step 210, a normal force is applied between an object to be moved and actuating ends of protruding portions attached to a vibrator beam. The vibrator beam has a generally elongated shape and has a largest dimension in a main extension direction. The protruding portions are attached to the vibrator beam by a respective attachment end. The protruding portions protrude from the vibrator beam in a beam flexural direction. The actuating ends, intended as the only interaction connections between the vibrator beam and the object to be moved, are situated opposite to the attachment ends. Resonance electrical signals are in step 220 provided to vibrator beam electrodes of a vibrator beam for exciting at least one vibrator beam active volume of electromechanically active material causing the vibrator beam active volumes to induce a resonant bending vibration in the vibrator beam in the beam flexural direction perpendicular to the main extension direction. In step 230, quasi-static electrical signals are provided, causing a quasi-static motion of the actuating ends of the protruding portions, superimposed on the resonant bending vibration. The procedure ends in step 299.

The combination of the resonant flexural vibration and the quasi-static motion of the actuating ends provides for a relatively energy efficient coarse motion in the ultrasonic range. The design of the present invention, however, also permits fine positioning to be performed. There are many different fine positioning methods. The most straight-forward is a stick-slip movement with both protruding portions in phase. This can be made with a flexural bending of the vibrator beam in a similar shape as in the resonant first flexural overtone, i.e. the flexural second harmonics. The vibrator beam is first bent fast enough to make the object to be moved to slip relative to the actuating ends of the protruding portions due to the inertia of the object. The vibrator beam is then bent back slowly, causing the actuating ends to move in the other direction to make a controlled movement with high resolution. The object to be moved can be scanned back and forth at low speed within the tilting range of the protruding portion and the resolution will essentially be determined by the scanning range divided by the voltage resolution of the voltage source.

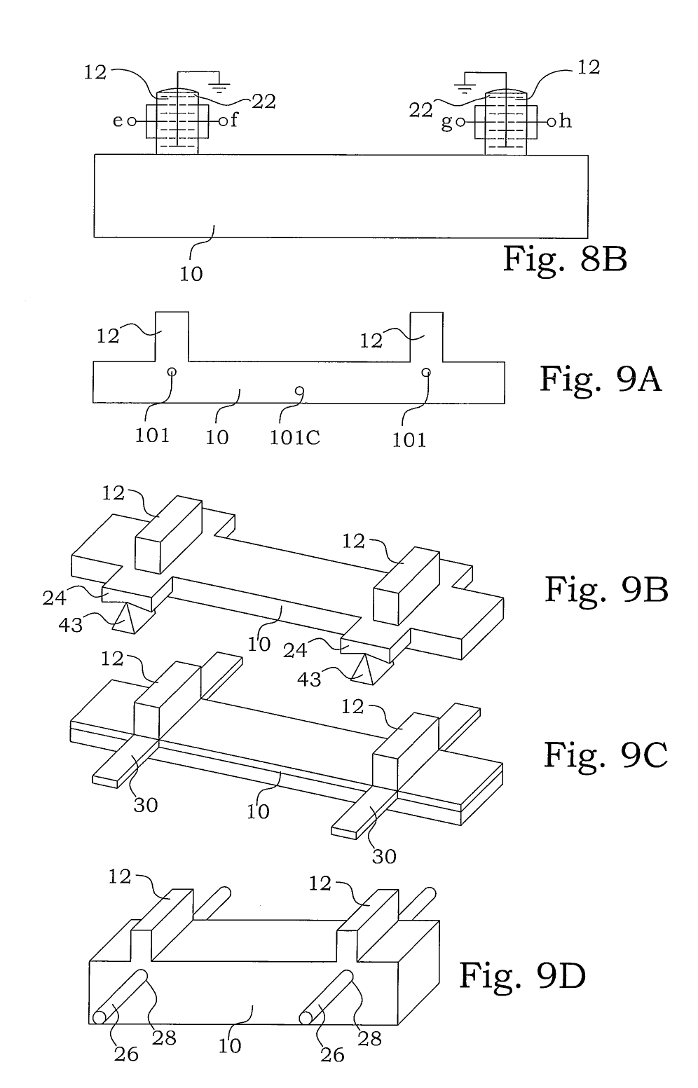

FIG. 8A illustrates schematically another embodiment of an electromechanical motor. In this embodiment, the protruding portions 12 are bimorph structures 22. This is particularly convenient when fine positioning is important. Each protruding portion 12 is then provided with two part volumes of electromechanically active material that can be excited independently from each other. These two volumes are firmly attached to each other along a plane perpendicular to the main extension direction. The bimorphs could be built either as d33 or d31 multilayers. When the two volumes of electromechanically active material are excited differently, the result will be a bending of the protruding portion 12 moving the actuating ends and possible drive pads along the main extension direction E. By providing such bimorph structure, the driving possibilities increases even more. The same kind of operation in the coarse positioning operation can be obtained by driving the bimorph structure by identical excitation signals. The bimorph will then expand and contract just as a single volume protruding portion and the operation is analogous to what has been described above.

By “bimorph structure” is understood a material that changes its shape by an applied electric voltage, field and/or current.

When coming to fine positioning, however, the bimorph structure opens up for other solutions as well. A stick-slip mechanism can be used also using bimorph protruding portions for controlled fine positioning. Fast bimorph bending of the protruding portions 12 in the horizontal direction, i.e. the main extension direction of the vibrator beam, is used for the slip action. A slow bending in the opposite direction with the drive pads and object to be moved in full friction contact results then in controlled fine positioning. This stick-slip mechanism can also be combined with a movement in the vertical direction to reduce the friction during the slip phase and/or increase the friction during the stick phase. The bimorph protruding portions can both bend horizontally and elongate vertically by a proper selection of selection of signals to the phases e/f and g/h in FIG. 8B. To elongate, both phases e and f (and the same for g and h) are activated with the same voltage signal, and to bend, different signals are applied to phases e and f (and analogously for g and h).

A somewhat different fine positioning method is to make pseudo-static walking with one protruding portion at a time. One of the protruding portions should retract fast to reduce the friction between the drive pad and the object and bend at the same time. The speed of retraction should be fast enough in relation to resistance to movement due to the inertia of the object to be movable bodies (typically vibrator beam and/or object to be driven). In that way this protruding portion will have made a small step when the friction forces are regained. The same type of movement can be made with the other protruding portion and by repetition of this sequence the object can be moved by small controlled walking steps.

The support of the vibrator beam has briefly been discussed further above. The vibrator beam should preferably be mechanically supported close to the nodal points for the flexural resonance used. For the second resonant flexural harmonic there are three nodes and these are typically in the positions as indicated in FIG. 9A. There are two symmetric possibilities to support the vibrator beam with their respective advantages and disadvantages. In the first case the vibrator beam 10 is only supported in the central node 101C. Since this node is located close to or at the bottom of the vibrator beam 10 the vibrator beam 10 could be supported from the bottom side of the vibrator beam 10. A more controlled support is to use outer nodes 101. These nodes are for certain choices of vibrator beam dimensions located higher up in the vibrator beam 10 and it is less advantageous to support the vibrator beam 10 from the bottom side, even if it is possible. To achieve a stiffer support along the vertical nodal position, the vibrator beam 10 could have protruding wings 24 at nodal vertical positions making it possible to support the vibrator beam 10 from the bottom side, as illustrated in FIG. 9B. Another stiff solution is to support the vibrator beam 10 by pin 26 in a hole 28, as illustrated in FIG. 9D. A more flexible solution is to use flexures 30 that extend sideways from the vibrator beam 10, as illustrated in FIG. 9C.

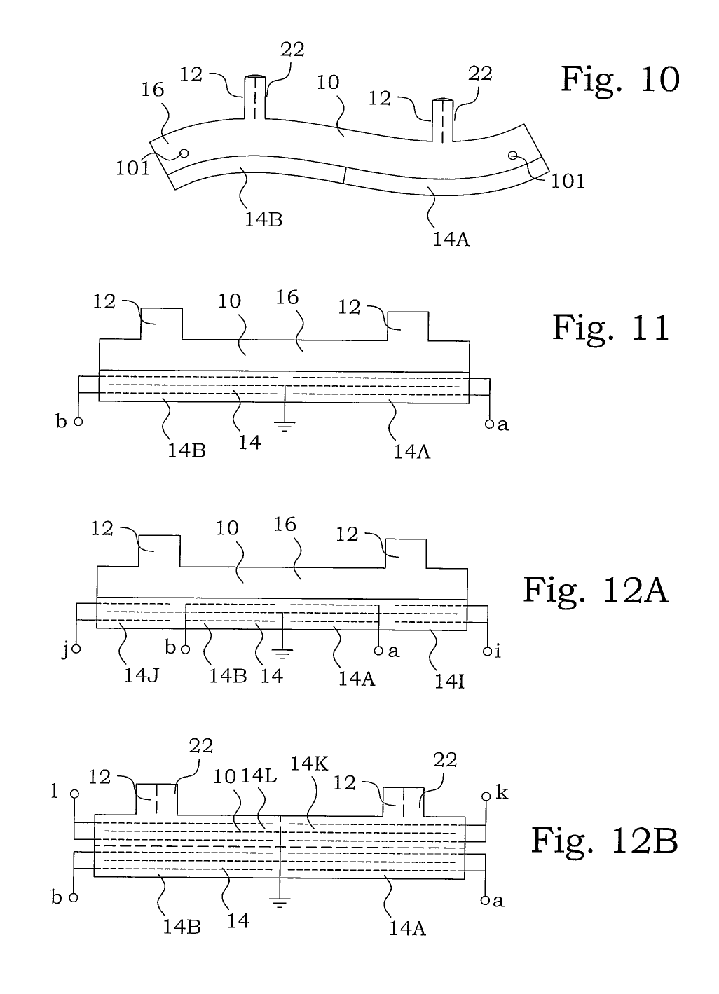

FIG. 10 illustrates another embodiment of an electromechanical motor 1. In this embodiment, the protruding portions 12 are attached to the vibrator beam 10 at positions in the main extension direction E corresponding to resonance anti-nodes of the bending motion of the vibrator beam 10. In this particular embodiment, the electromechanical motor 1 is intended to be driven with the second harmonics flexural resonance. When driving the vibrator beam 10 in this resonance, the protruding portions 12 will move essentially up and down in the figure, i.e. in the beam flexural direction B, c.f. FIG. 4D. The resonance motion in this embodiment thereby provides the lifting movement.

The movement of the drive pads in the main extension direction E, i.e. the intended direction of the object 2 to be moved, can be made in different ways. The most straight-forward is to use protruding portions 12 having bimorph structures 22, in analogy with what has been presented above. A quasi-static operation of these bimorph structures 22 provides a motion of the actuating ends 11, preferably provided with drive pads 19. A combination of the resonant motion and the quasi-static motion provides the movement of the object to be moved, when provided with the appropriate phase shift. In this case, the movement can be controlled quasi-statically within the full stroke of the bimorph protruding portion 12. There are many advantages of this solution. The ultrasonic vibration in the vertical direction, i.e. in the beam flexural direction B, combined with a quasi-static movement in the horizontal direction, i.e. in the intended main motion direction, makes it possible to move the object with a very high dynamic speed range. Most important is to be able to drive the electromechanical motor 1 controlled at a very small fraction of the top speed without any audible sound. This is not possible with conventional ultrasonic motors.

In an alternative embodiment, the protruding portions can be provided as monomorphs, having one passive part and one active part. By excitation of the active part, a bending of the protruding portion can be achieved, which together with the resonant lifting motion can give rise to an elliptic path for moving the object to be moved. Thus, the protruding portion active volumes and the protruding portion electrodes are arranged for causing at least a bending of the protruding portion perpendicular to the beam flexural direction when a respective protruding portion active volume is excited, irrespective of whether the bending is caused by a bimorph or monomorph structure.

By “monomorph structure” is understood the general type of structure which has one controllable electromechanical section perpendicular to the main extension of the structure. When the section is activated the shape change will result in a bending of the structure.

In particular when using the resonance for achieving the lifting action, the interaction between the drive pads and the object to be driven becomes of importance. The spring constants of the drive pads and/or the object to be moved are preferably matched with the associated spring constant of the vibrator beam. In other words, an associated spring constant of the vibrator beam is matched with a spring constant associated with the interaction of the object to be moved and the actuating ends. The associated spring constant of the vibrator can estimated from:

$$ω = \sqrt{\frac{k}{m}} , \qquad ( 1 )$$

where ω is the used resonance frequency of the vibrator beam, m the equivalent mass of the vibrator beam and k the spring constant. The matching is, however, not extremely critical. The motor operates reasonably well with in an order of magnitude in difference between the spring constants of the vibrator beam and drive pad and/or object to be moved. Preferably, the spring constants should be within a factor of 3 from each other.

One factor to consider when designing this type of motor is the falling distance. When the motor is operated dynamically at resonance, the drive pads are ideally in contact with the object to be moved during a controlled fraction of the drive cycle time. Often an ultrasonic motor is designed to be in friction contact during half the drive cycle. During the remaining part of the period the normal forces that are applied in the vertical direction will accelerate the vibrator beam and/or the object to be moved against each other. If the frequency is low, i.e. the drive cycle time is long, there is plenty of time for the object and/or vibrator beam to move relative each other in the beam flexural direction and a “falling” distance can be calculated. Too low frequency will make it impossible to design a motor to operate since the object and/or vibrator beam will “fall” a larger distance that the vertical stroke of the vibrator assembly. At very high frequency the inertia of the object and/or the vibrator beam essentially keeps both these mechanical components at the same relative distance during the full drive cycle and the drive pads are in contact with the object just a small fraction of the cycle. This fraction is not determined by the “falling” distance but rather the stiffness of the deformable details in the vibrator assembly and object in relation to the normal force applied. In practice the choice of contact fraction is a compromise. The larger fraction is used for higher forces while shorter contact fractions are used to reduce wear in the motor. When the motors are getting small the inertia is also reduced. Typically this means that the operation frequency should be higher than that of a larger motor to keep a similar fraction of contact time during the drive cycle. In some cases it is not convenient to increase the driving frequency too much. Particularly not when active protruding portions are used since these are not operated in resonance and the power consumption will typically be high with possible risks for overheating. For these cases it will be necessary to accept “falling” distances that are higher than the ideal situation. To compensate for the larger movements perpendicular to the intended main motion direction due to acceleration of vibrator beam and/or object to be moved the phase between the controlled movement, parallel and perpendicular to the intended main motion direction, of the protruding portions is adjusted to optimize the performance. It will be noticed that the phase optimum will depend on the normal force that is used to create friction contact between drive pads and the object to be moved.

In yet another embodiment of an electromechanical motor 1, schematically illustrated in FIG. 11, the protruding portions 12 are passive structures that can be integrated with the vibrator beam 10 or simply being assembled on the vibrator beam 10. This type of design is simpler to manufacture and build. Since the protruding portions 12 are not active, the movement in the beam flexural direction B has to be made with the active elements on the bottom side of the vibrator beam 10. One solution is to support the vibrator beam 10 in the middle nodal position 101C and use the vibrator beam active volumes 14A, 14B to bend the vibrator quasi-statically. A horizontal movement is then based on pseudo-static bending of the vibrator beam 10. A quasi-static signal that makes one of the halves of the beam bend so that the legs tilts in the driving direction is superimposed on the signal that generates the resonant flexural vibration. When the vibrator is operated at the second harmonic it will not be possible to make quasi-static flexural bending similar to the fundamental resonance frequency but rather bending of the outer part of the vibrator beam. This bending will still be sufficient to reduce the friction between drive pads and object to be driven. This means that the quasi-static electrical signals are provided to the vibrator beam electrodes, superimposed to the resonance electrical signals.

Other methods to create a vertical movement of the passive legs are based on having the protruding portions and/or supports against the motor housing displaced in relation to the nodal positions. A voltage signal superimposed on the signal driving the resonant flexural vibration will result in a pseudo-static bending that is superimposed on the resonant movement.

In FIG. 12A, another embodiment of an electromechanical motor 1 is disclosed. In this embodiment, the vibrator beam active volume and said vibrator beam electrodes are configured for exciting more than two part volumes of the vibrator beam active volume 14 independently of each other, in this particular embodiment four part volumes 14A, 14B, 14I and 14J. Such arrangements allow for further possibilities of making pseudo-static motions superimposed on a bending resonance.

In FIG. 12B, another embodiment shows a vibrator beam 10 entirely formed in electromechanically active material. In this way the manufacturing is greatly simplified and depending on desired performance, certain parts of the vibrator beam may be left inactive. In this particular embodiment, the vibrator beam active volume 14 has four independently excitable part volumes 14A, 14B, 14,L, 14K.

In alternative embodiments, the entire vibrator beam may be made of an electromechanically active material, but only part of it is provided with electrodes. The remaining parts then operate as passive portions.

The electromechanically active material can also be provided as several active volumes, which cooperate for creating the requested motions.

As mentioned further above, also other resonances than the second harmonics can be useful. In FIGS. 4A and 4C, one may notice that the protruding portions perform reciprocating motions in the vibrator beam extension direction. However, the respective motions of the two protruding portions are opposite to each other. In order to utilize such flexural resonances, the quasi-static motion applied to the protruding portions causing the lifting part of the motion then has to be phase-shifted between the two protruding portions. When one protruding portion moves in the intended driving direction, it can be put in an extended state, while the other protruding portion moving in the opposite direction is in its contracted state in order to minimize any interaction with the body to be moved.

Similarly, by providing protruding portions at the two outermost anti-node positions of the third harmonics flexural resonance (c.f. FIG. 3C), in-phase vertical motion can be achieved.

There are also possible configurations involving more than two protruding portions. By e.g. provide providing protruding portions at all anti-node positions of the third harmonics flexural resonance (c.f. FIG. 3C), all protruding portions will move linearly in the flexural direction. However, two of them will be in phase, while the third will be phase shifted 180 degrees. There are of course, endless possibilities to combine different flexural resonances, number of protruding portions and positions of the protruding portions for achieving a moving action. The most preferred embodiment is typically determined by the requests of the intended application.

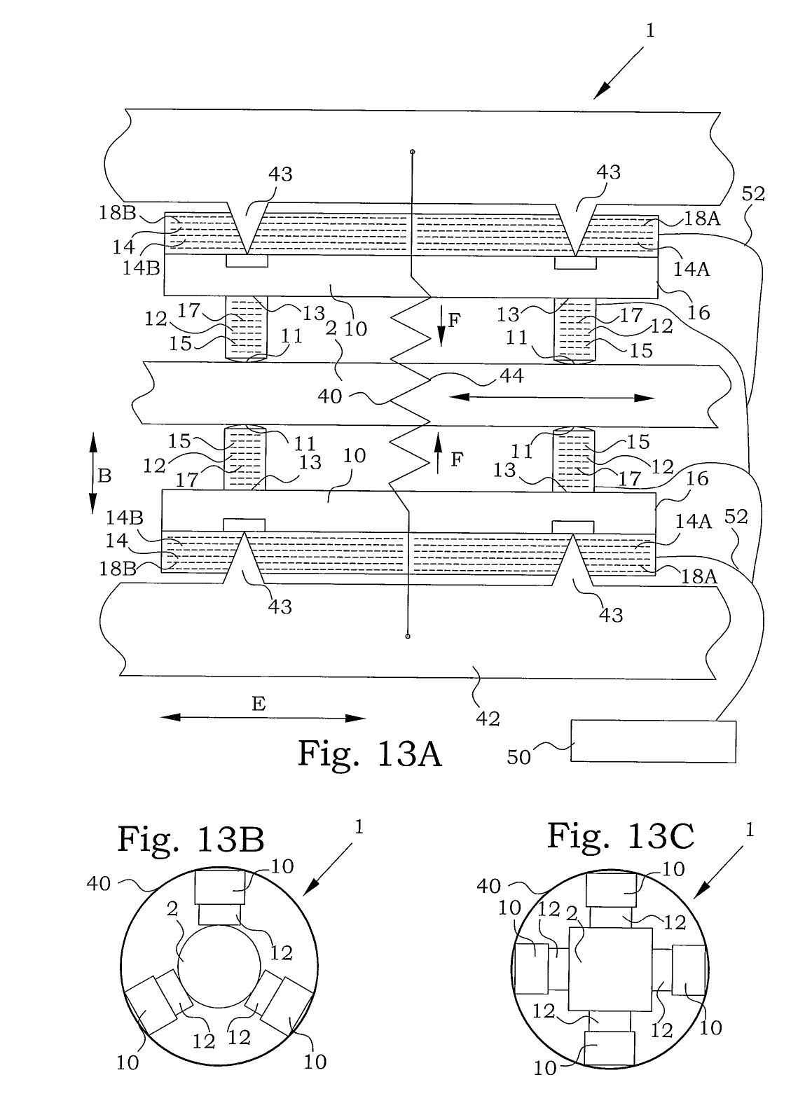

As in other types of electromechanical motors, motors according to the present ideas can also be provided e.g. in so called tandem configurations. This is schematically illustrated in FIG. 13A. Two vibrator beams 10 are then provided on opposite sides of an object 2 to be moved, and the normal force F providing arrangement then provides a force between the two vibrator beams. Also configurations with three or more vibrator beams 10 around a central object 2 to be driven are easily provided by anyone skilled in the art. Schematic illustrations in an axial direction of such configurations are illustrated in FIGS. 13B and 13C.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1.-16. (canceled)

17. An electromechanical motor, comprising:
an object to be moved;
a vibrator beam, having a generally elongated shape;
said vibrator beam having a largest dimension in a main extension direction;
said vibrator beam having at least one vibrator beam active volume of electromechanically active material and vibrator beam electrodes for exciting said at least one vibrator beam active volume;
said at least one vibrator beam active volume and said vibrator beam electrodes being arranged for enabling bending said vibrator beam in a beam flexural direction perpendicular to said main extension direction when said at least one vibrator beam active volume being excited;
at least two protruding portions attached to said vibrator beam by a respective attachment end;
said protruding portions protruding from said vibrator beam in said beam flexural direction;
said protruding portions having actuating ends, arranged as the only interaction connections between said vibrator beam and said object to be moved, said actuating ends being situated opposite to said attachment ends;
a normal force providing arrangement, configured for applying a normal force between said object to be moved and said actuating ends;
control electronics, configured for providing electrical signals for excitement of electromechanically active material; and
electrical connections connecting said control electronics and said vibrator beam electrodes;
said control electronics being configured for providing electrical signals causing said at least one vibrator beam active volume to induce a resonant bending vibration in said vibrator beam;
said control electronics being further configured for providing electrical signals causing a quasi-static motion of said actuating ends of said protruding portions, superimposed on motion caused by said resonant bending vibration;
said control electronics being further configured for providing electrical signals causing a stick-slip movement of both said protruding portions in phase;
said stick-slip movement comprising a fast movement of said actuating ends causing a movement relative to said object combined with a controlled movement in the other direction with the actuating ends in full friction contact with said object.

18. The electromechanical motor according to claim 17, wherein said at least one vibrator beam active volume and said vibrator beam electrodes are configured for exciting two part volumes of said at least one vibrator beam active volume independently of each other.

19. The electromechanical motor according to claim 18, wherein said at least one vibrator beam active volume and said vibrator beam electrodes are configured for exciting more than two part volumes of said at least one vibrator beam active volume independently of each other.

20. The electromechanical motor according to claim 17, wherein said at least one vibrator beam active volume and said vibrator beam electrodes are configured for allowing excitation of a bending motion of said vibrator beam of an at least second harmonics.

21. The electromechanical motor according to claim 20, wherein said protruding portions are attached to said vibrator beams at positions in the main extension direction corresponding to resonance nodes of said bending motion of said vibrator beam.

22. The electromechanical motor according to claim 20, wherein said protruding portions are attached to said vibrator beam at positions in the main extension direction corresponding to resonance anti-nodes of said bending motion of said vibrator beam.

23. The electromechanical motor according to claim 22, wherein an associated spring constant of said vibrator beam is matched with a spring constant associated with the interaction of said object to be moved and said actuating ends.

24. The electromechanical motor according to claim 23, wherein said vibrator beam is supported to a housing and/or said normal force providing arrangement at locations at nodes of said bending motion of said vibrator beam.

25. The electromechanical motor according to claim 17, wherein said electrical signals causing a stick-slip movement of both said protruding portions in phase are arranged for causing a flexural bending of said vibrator beam in a shape as in the flexural second harmonics.

26. The electromechanical motor according to claim 17, wherein said protruding portions having at least one respective protruding portion active volume of electromechanically active material and respective protruding portion electrodes for exciting said at least one protruding portion active volume, said electrical signals causing said quasi-static motion being provided to said protruding portion electrodes.

27. The electromechanical motor according to claim 26, wherein said at least one protruding portion active volumes and said protruding portion electrodes being arranged for causing at least a dimension change of said protruding portion in said beam flexural direction when a respective said at least one protruding portion active volume being excited.

28. The electromechanical motor according to claim 26, wherein said at least one protruding portion active volumes and said protruding portion electrodes being arranged for causing at least a bending of said protruding portion perpendicular to said beam flexural direction when a respective said at least one protruding portion active volume being excited.

29. The electromechanical motor according to claim 28, wherein said protruding portion active volumes comprise a respective bimorph structure of independently excitable part volumes.

30. The electromechanical motor according to claim 28, wherein said electrical signals causing a stick-slip movement of both said protruding portions in phase are provided to said protruding portion electrodes, causing a fast bimorph bending of said protruding portions in said main extension direction and a slow bending of said protruding portions in the opposite direction.

31. The electromechanical motor according to claim 26, wherein said protruding portion active volumes and said protruding portion electrodes are configured for exciting said protruding portion active volumes by a d31 mechanism.

32. The electromechanical motor according to claim 26, wherein said protruding portion active volumes and said protruding portion electrodes are configured for exciting said protruding portion active volumes by a d33 mechanism.

33. The electromechanical motor according to claim 17, wherein said electrical signals causing said quasi-static motion of said actuating ends of said protruding portions being provided to said vibrator beam electrodes, superimposed to said electrical signals causing said at least one vibrator beam active volume to induce said resonant bending vibration in said vibrator beam.

34. A method for driving an electromechanical motor, comprising the steps of:
applying a normal force between an object to be moved and actuating ends of at least two protruding portions attached to a vibrator beam;
said vibrator beam, having a generally elongated shape;
said vibrator beam having a largest dimension in a main extension direction;
said at least two protruding portions being attached to said vibrator beam by a respective attachment end;
said protruding portions protruding from said vibrator beam in said beam flexural direction;
said actuating ends, intended as the only interaction connections between said vibrator beam and said object to be moved, being situated opposite to said attachment ends;
providing electrical signals to vibrator beam electrodes of a vibrator beam for exciting at least one vibrator beam active volume of electromechanically active material causing said at least one vibrator beam active volume to induce a resonant bending vibration in said vibrator beam in a beam flexural direction perpendicular to said main extension direction;
providing electrical signals causing a quasi-static motion of said actuating ends of said protruding portions, superimposed on said resonant bending vibration; and
providing electrical signals causing a stick-slip movement of both said protruding portions in phase;
said stick-slip movement comprising a fast movement of said actuating ends causing a movement relative to said object combined with a controlled movement in the other direction with the actuating ends in full friction contact with said object.

35. The electromechanical motor according to claim 18, wherein said at least one vibrator beam active volume and said vibrator beam electrodes are configured for allowing excitation of a bending motion of said vibrator beam of an at least second harmonics.

36. The electromechanical motor according to claim 19, wherein said at least one vibrator beam active volume and said vibrator beam electrodes are configured for allowing excitation of a bending motion of said vibrator beam of an at least second harmonics.
